(19) United States
(12) Patent Application Publication
(10) Pub. No.: US 2010/0078290 A1
(43) Pub. Date: Apr. 1, 2010

(54) AUTOMATIC VENDING MACHINE WITH USER'S IDENTITY RECOGNITION FUNCITON

(75) Inventor: Hung-Yi Chang, Chilung City (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, Taipei (TW)

(21) Appl. No.: 12/238,456

(22) Filed: Sep. 26, 2008

(51) Int. Cl. G07F 7/04

(52) U.S. Cl. 194/206

(57) ABSTRACT

An automatic vending machine for selling controlled commodities is disclosed to include a host, a card-swiping unit, a bill acceptor unit and a coin acceptor unit. The host has installed in the face panel thereof multiple display compartments for accommodating commodities to be sold, and a commodity take-out port and a coin-return outlet located on the face panel near the bottom side. The card-swiping unit has a card-swiping slot installed in the face panel of the host and an authenticity recognition module and an image sensor module for recognizing the user's identity. The bill acceptor unit has an insertion slot for the insertion of a card or bill, a transmission device for transferring each inserted card or bill, and a recognition device for recognizing the authenticity of each inserted card or bill. The coin acceptor unit has an induction coil module for detecting the authenticity and value of each inserted coin.

### BACKGROUND OF THE INVENTION

1. Field of the Invention

The present invention relates to automatic vending machines and more particularly, to an automatic vending machine with user's identity recognition function, which runs selling of a controlled commodity to a user over a predetermined age only after the user's identity has been recognized through a card-swiping unit and the user has inserted a true bill or coin(s) subject to the price of the commodity to be purchased.

2. Description of the Related Art

Following fast development of technology, our mode of living has been changed, and different automatic vending machines are used everywhere to sell different products without serviceman. These automatic vending machines are highly invited for the advantage of saving much labor and bringing convenience to people.

Further, Q-shop has the advantages of scientific intelligence, quick service, and quick finish of payment. A Q-shop may provide automatic vending machines for vending drinks, cigarettes, tickets, ice creams, tickets, memorial coins, key rings, or even hamburgers and noodles. Nowadays, many virtual shops are established to make online shopping, allowing shoppers to shop across millions of products.

However, regular vending machines do not limit the sales to any person of any age. Therefore, regular vending machines commonly sell popular goods such as fruit juice beverages, carbonated beverages, food, etc. These vending machines cannot sell age-controlled merchandises such as cigarettes or alcohol drinks, or other controlled merchandises such as drugs, strong acids/alkalines detergent, knives or other hazardous items. To prohibit young children from buying age-controlled merchandises or unqualified people from buying controlled items, a vending machine for vending age-controlled or controlled merchandises must be equipped with a security system to recognize the age or identity of the consumer.

Therefore, designing an automatic vending machine for vending age-controlled or specifically controlled merchandises must consider the recognition of the traders' real age or identity.

### SUMMARY OF THE INVENTION

The present invention has been accomplished under the circumstances in view. According to one aspect of the present invention, the automatic vending machine comprises a host, a card-swiping unit, a card recognition unit, a bill acceptor unit, and a coin acceptor unit. The host comprises a face panel, a plurality of display compartments formed in the face panel for accommodating commodities to be sold, a plurality of buttons respectively installed in the face panel corresponding to the display compartments for a user to select the commodity to be purchased, a take-out port formed in the face panel near the bottom side for enabling a user to take out each purchased commodity, and a coin-return outlet for returning an inserted coin. When a user is going to purchase a controlled commodity from the automatic vending machine, he or she must insert a card into the card-swiping unit or card recognition unit for identity recognition. The host of the automatic vending machine will start the transaction only after the identity of the user has been identified and approved and the user has inserted a true bill or coin(s) into a bill acceptor or coin acceptor in the face panel of the host subject to the price of the commodity to be purchased, avoiding selling of any controlled commodity to an unqualified person.

According to another aspect of the present invention, when the host, the card-swiping unit, the bill acceptor unit, the card recognition unit and the coin acceptor unit are not in use, the host turns off the power supply of the card-swiping unit, the bill acceptor unit, the card recognition unit and the coin acceptor unit and keeps only the card type recognition module of the card-swiping unit, the sensor switch of the bill acceptor, the start switch of the card recognition unit and the sensor module of the coin acceptor in the power-on status. When a user inserted a card to trigger the card type recognition module of the card-swiping unit, the sensor switch of the bill acceptor, the start switch of the card recognition unit or the sensor module of the coin acceptor unit, the host immediately transmits power supply to the card-swiping unit, the card recognition unit, the bill acceptor unit and the coin acceptor unit for card/bill/coin authenticity and bill/coin value recognition. After the end of each transaction, the host stops the supply of power supply again, thereby saving power consumption.

### BRIEF DESCRIPTION OF THE DRAWINGS

FIG. 1 is a schematic drawing showing the outer appearance of an automatic vending machine according to the present invention.

FIG. 2 is a sectional side view of the card-swiping unit of the automatic vending machine according to the present invention.

FIG. 3 is a sectional side view of the bill acceptor unit of the automatic vending machine according to the present invention.

FIG. 4 is a sectional side view of the license recognition unit of the automatic vending machine according to the present invention.

FIG. 5 is a sectional side view of the coin acceptor unit of the automatic vending machine according to the present invention.

FIG. 6 is a system block diagram of the present invention.

FIG. 7 is a flow chart showing boosting of the power-saving function according to the present invention.

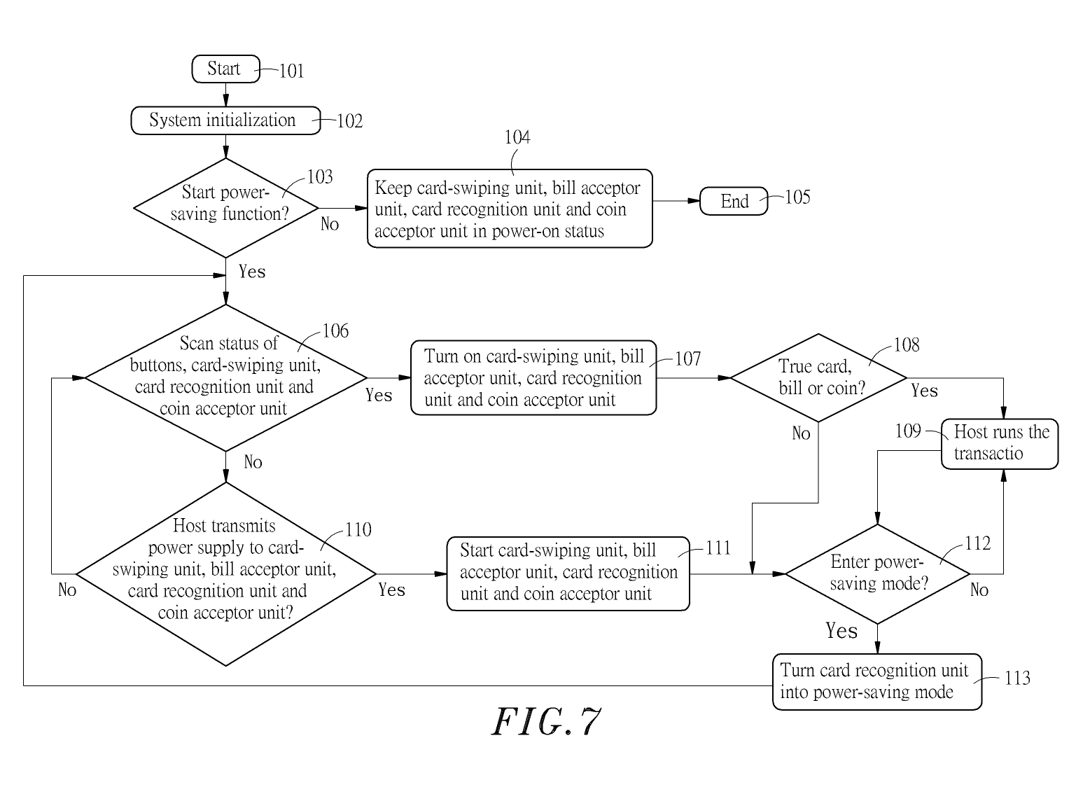

FIG. 8 is a schematic drawing showing the outer appearance of an alternate form of the automatic vending machine according to the present invention.

FIG. 9 is a schematic drawing showing the outer appearance of another alternate form of the automatic vending machine according to the present invention.

### DETAILED DESCRIPTION OF THE PREFERRED EMBODIMENT

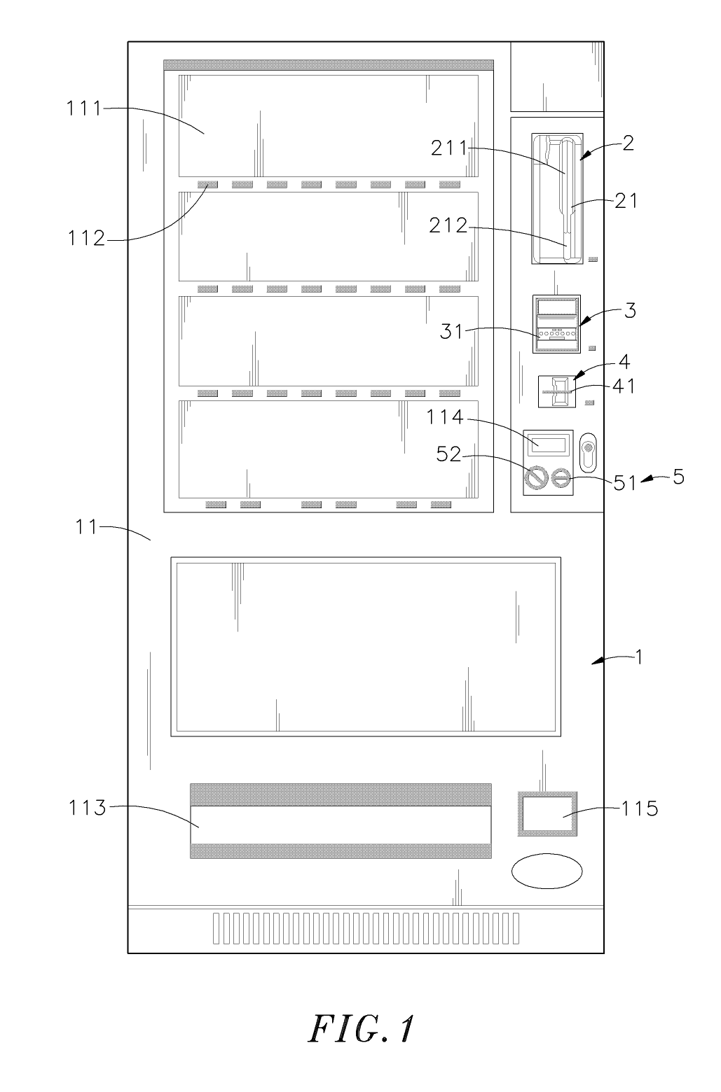

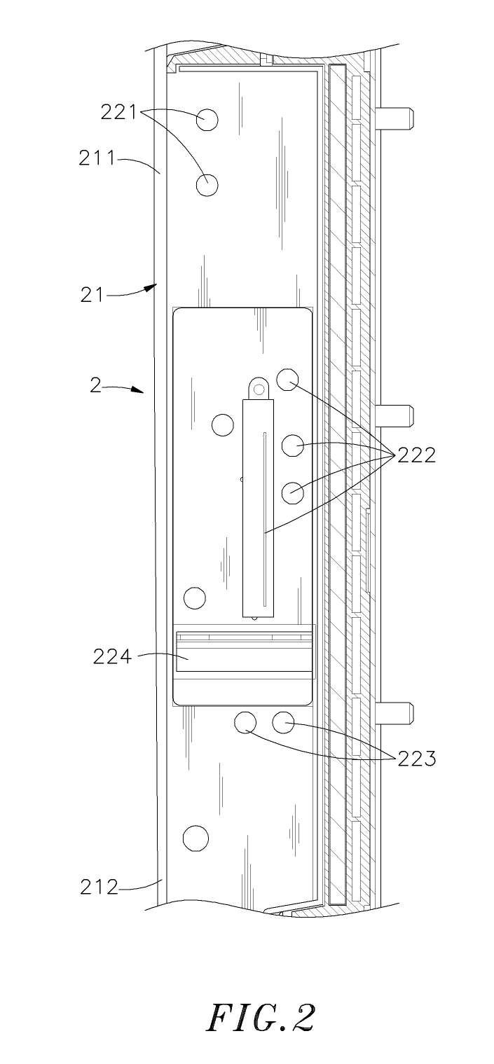

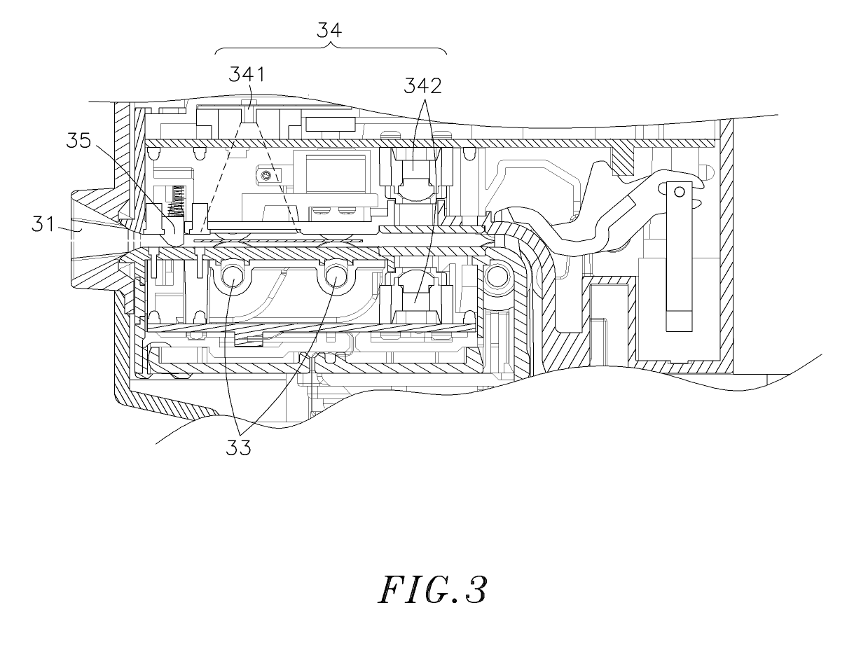

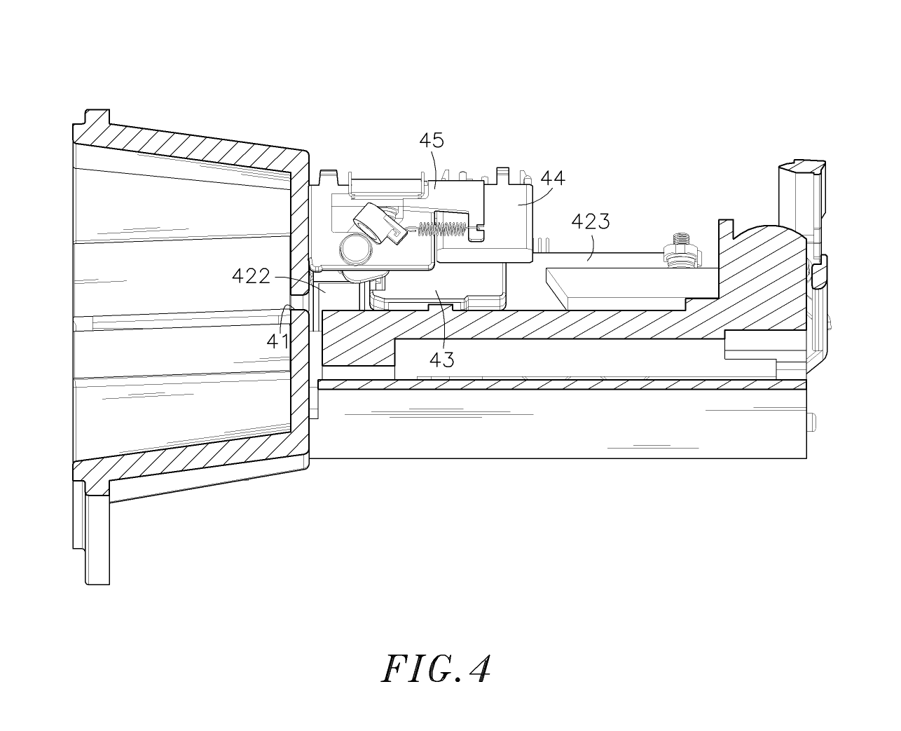

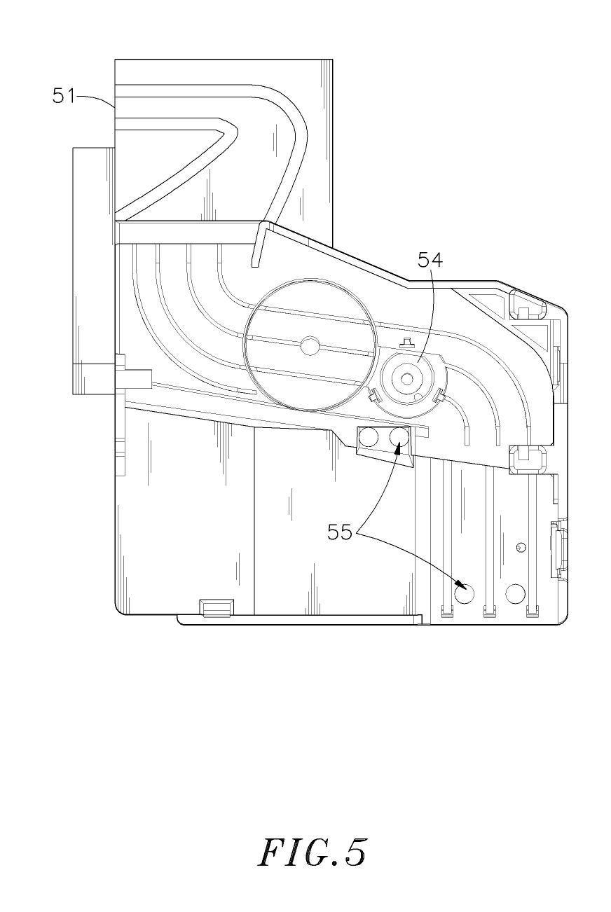

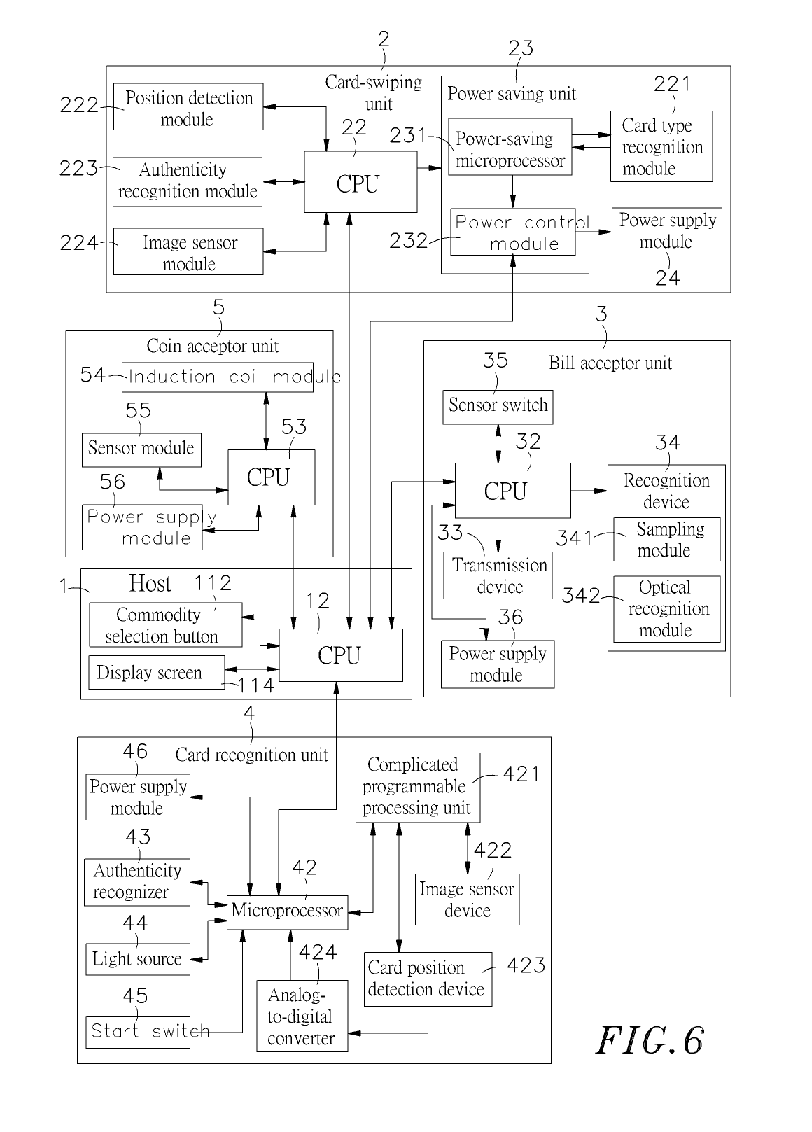

Referring to FIGS. 1-6, an automatic vending machine in accordance with the present invention is shown comprising a host 1, a card-swiping unit 2, a bill acceptor unit 3, a card recognition unit 4 and a coin acceptor unit 5.

The host 1 comprises a face panel 11 disposed at the front side, and a CPU (central processing unit) 12 mounted on the inside. The face panel 11 comprises plurality of display compartments 111 disposed at an upper side, a plurality of commodity selection buttons 112 respectively arranged corresponding to the display compartments 111, a product take-out port 113 disposed near the bottom side, a display screen 114 disposed at one lateral side relative to the display compartments 111, and a coin-return slot 115 disposed at one lateral side relative to the product take-out port 113.

The card-swiping unit 2 is installed in the face panel 11 of the host 1, comprising a card-swiping slot 21 that has an upper card-insertion section 211 and a lower card-withdrawal section 212, a CPU (central processing unit) 22 electrically connected with the CPU 12 of the host 1, a card type recognition module 221, a position detection module 222, an authenticity recognition module 223 and an image sensor module 224 respectively electrically connected to the CPU 22, a power saving unit 23 electrically connected to the CPU 22 and electrically connected with the card type recognition module 221, and a power supply module 24. The power saving unit 23 comprises a power-saving microprocessor 231 and a power control module 232. The power control module 232 is electrically connected with the CPU 12 of the host 1. The power supply module 24 is electrically connected to the power control module 232.

The bill acceptor unit 3 is installed in the face panel 11 of the host 1, comprising an insertion slot 31 for the insertion of a card (license) and a bill, a CPU (central processing unit) 32 electrically connected with the CPU 12 of the host 1, a transmission device 33, a recognition device 34, a sensor switch 35 and a power supply module 36 respectively electrically connected to the CPU 32. The recognition unit 34 is comprised of a sampling module 341 and an optical recognition module 342.

The card recognition unit 4 is installed in the face panel 11 of the host 1, comprising a card slot 41 for the insertion of a card, a microprocessor 42 electrically connected with the CPU 12 of the host 1, a complicated programmable processing unit 421 electrically connected with the microprocessor 42, an image sensor device 422 electrically connected with the programmable processing unit 421, a card position detection device 423 electrically connected to the programmable processing unit 421, an analog-to-digital converter 424 electrically connected between the card position detection device 423 and the microprocessor 42, an authenticity recognizer 43 electrically connected with the microprocessor 42, a light source 44 electrically connected with the microprocessor 42, a start switch 45 electrically connected to the microprocessor 42, and a power supply module 46 respectively electrically connected with the microprocessor 42.

The coin acceptor unit 5 is installed in the face panel 11 of the host 1, comprising a coin slot 51, a coin-return button 52 disposed in the front side of the face panel 11, a CPU (central processing unit) 53 electrically connected with the CPU 12 of the host 1, and an induction coil module 54, a sensor module 55 and a power supply module 56 respectively electrically connected with the CPU 53.

According to the aforesaid embodiment, the display compartments 111 are disposed at the upper side of the face panel 11, the product take-out port 113 and the coin-return slot 115 are disposed near the bottom side of the face panel 11, and the display screen 114, the card-swiping unit 2, the bill acceptor unit 3, the card recognition unit 4 and the coin acceptor unit 5 are disposed at the right side relative to the display compartments 111. However, this positioning arrangement is not a limitation. For example, the display compartments 111 can be disposed at the upper right side of the face panel 11; the card-swiping unit 2, the bill acceptor unit 3, the card recognition unit 4 and the coin acceptor unit 5 may be not arranged in proper order from the top side toward the bottom side; the bill acceptor unit 3 may be arranged below the card recognition unit 4 or above the card-swiping unit 2. The face panel 11 of the host 1 simply provides commodity display, coin insertion, card recognition, coin return and sale item take-out functions for enabling a user to perform the necessary actions in purchasing a sale item. Therefore, the position arrangement of the component parts may be changed without departing from the spirit and scope of the invention

When the host 1 has controlled items stored in the display compartments 111 for selling to persons over a predetermined age or having a particular identity and when a user wishing to purchase either controlled item from the automatic vending machine, the user must insert a card into the card-swiping slot 21 of the card-swiping unit 2, the insertion slot 31 of the bill acceptor unit 3 or the card slot 41 of the card recognition unit 4 for identity recognition at first. The user can start the purchase operation only after the inserted card has been recognized and approved.

When a user inserted a card into the upper card-insertion section 211 of the card-swiping slot 21, the card type recognition module 221 recognizes the type of the inserted card, and then the position detection module 22 detect the position of the inserted card. When the inserted card reached a predetermined position in the card-swiping slot 21, the authenticity recognition module 223 and the image sensor module 224 are started to recognize the authenticity of the inserted card and to pick up the image of the inserted card respectively. By means of an optical character recognition technique, the legal age of the 1 cardholder is recognized. When the inserted card reaches the lower card-withdrawal section 212 of the card-swiping slot 21, the user can then withdraw the card, completing the card swiping action.

When a user inserted a card/bill into the insertion slot 31 of the bill acceptor unit 3, the transmission device 33 carries the inserted card/bill toward the inside of the host 1 to a predetermined position for enabling the sampling module 341 and optical recognition module 342 of the recognition device 34 to recognize the authenticity of the inserted card/bill, the birthday data carried on the inserted card and the value of the inserted bill.

When a user inserted a card into the card slot 41 of the card recognition unit 4, the microprocessor 42 directly starts the authenticity recognizer 43 and the light source 44 and at the same time sends a signal to the complicated programmable processing unit 421 to start the image sensor device 422 and the card position detection device 423, so that he card position detection device 423 can detect the position of the inserted card, the image sensor device 422 can pick up the image of the inserted card when the inserted card reached a predetermined position, and the authenticity recognizer 43 can recognize the authenticity of the inserted card.

After a user's card has been recognized and approved and a bill or coins has been inserted into the bill acceptor unit 3 or coin acceptor unit 5 and the true value of the inserted bill or coin has been identified, the display screen 114 displays the value of the inserted bill or coin. At this time, the user can operate the buttons 112 to select the desired item, causing one selected item to fall from one display compartment 111 to the product take-out port 113, and the coin or coins to be returned, if any, will fall to the coin-return slot 115. Thus, the user can take the purchased product and the change from the product take-out port 113 and the coin-return slot 115. If a user inserted a wrong bill or coin or wants to renege after insertion of a bill or coin, the user can operate the coin-return button 52 to return the inserted bill or coin from the insertion slot 31 of the bill acceptor unit 3 or the coin slot 51 of the coin acceptor unit 5 to the coin-return slot 115, and then pick up the returned bill or coin.

Referring to FIGS. 1˜7, the host 1 of the automatic vending machine provides a power saving function. When a user inserted a card/bill/coin or pressed one button 112, the power saving function runs subject to the following procedure:
101 Start
102 System initialization.
103 Scan power saving function and then determine whether or not to start the power saving function, and then proceed to step (104) when negative, or step (106) when positive.
104 The host 1 transmits power supply to keep the card-swiping unit 2, the bill acceptor unit 3, the card recognition unit 4 and the coin acceptor unit 5 in the power-on status.
105 End.
106 Scan whether or not any button 112 has been pressed, a card has been inserted into the card-swiping unit 2 or the card recognition unit 4, or a coin has been inserted into the coin acceptor unit 5, and then proceed to step (107) when positive, or step (110) when negative.
107 The card type recognition module 221 of the card-swiping unit 2, the sensor switch 35 of the bill acceptor unit 3, the start switch 45 of the card recognition unit 4 or the sensor module 55 of the coin acceptor unit 5 sends a signal to the host 1, causing the host 1 to transmit power supply to the card-swiping unit 2, the bill acceptor unit 3, the card recognition unit 4 and the coin acceptor unit 5.
108 The card-swiping unit 2, the bill acceptor unit 3, the card recognition unit 4 or the coin acceptor unit 5 runs a recognition process to determine whether or not the inserted card, bill or coin is a true card, bill or coin, and then process to step (109) when the authenticity of the inserted card, bill or coin is identified, or step (112) when the authenticity of the inserted card, bill or coin is denied.
109 The card-swiping unit 2, the bill acceptor unit 3, the card recognition unit 4 or the coin acceptor unit 5 sends a signal to the host 1 for enabling the host 1 to run commodity selling operation, and then proceed to step (112).
110 Determine whether or not the host 1 has transmitted power supply to the card-swiping unit 2, the bill acceptor unit 3, the card recognition unit 4 and the coin acceptor unit 5, and then proceed to step (106) when negative, or step (111) when positive.
111 Transmit power supply to start the card-swiping unit 2, the bill acceptor unit 3, the card recognition unit 4 and the coin acceptor unit 5.
112 Determine whether or not the card-swiping unit 2, the bill acceptor unit 3, the card recognition unit 4 and the coin acceptor unit 5 need to enter the power saving mode, and then proceed to step (109) when negative, or step (113) when positive.
113 The host 1 sends a signal to turn off power supply and to enter the power saving mode, and then proceed to step (106).

When the host 1 is not operated and the power saving function is in action, the host 1 stops power supply from the card-swiping unit 2, the bill acceptor unit 3, the card recognition unit 4 and the coin acceptor unit 5 while keeping the card type recognition module 221 of the card-swiping unit 2, the sensor switch 35 of the bill acceptor unit 3, the start switch 45 of the card recognition unit 4 and the sensor module 55 of the coin acceptor unit 5 in the power-on status. If a user presses one button 112 or inserts a card into the card-swiping unit 2 or card recognition unit 4 or a coin into the coin acceptor unit 5 at this time, the card-swiping unit 2, card recognition unit 4 or coin acceptor unit 5 will send a signal to the host 1 so that the host 1 will transmit power supply to start the card-swiping unit 2, the bill acceptor unit 3, the card recognition unit 4 and the coin acceptor unit 5 in recognizing the authenticity of the card, bill or coin. Because the host 1 may do no work within a long period of time, this power saving function saves much the consumption of power supply.

When a person inserts a card into the upper card-insertion section 211 of the card-swiping slot 21 of the card-swiping unit 2, the card will trigger the card type recognition module 221 (formed of reflective or penetrative optical sensor means, mechanical sensor means, or any other type of sensor means). After the inserted card reached a predetermined position in the upper card-insertion section 211, the user can then move the card downwards along the card-swiping slot 21. At this time, the card type recognition module 221 detects the type of the inserted card, and then the authenticity recognition module 223 is started to recognize the authenticity of the inserted card by means of identifying the anti-counterfeit characteristics of the inserted card and the image sensor module 224 is started to identify the age data carried on the inserted card. When the card is moved to the lower card-withdrawal section 212 of the card-swiping slot 21, the user can then withdraw the card, ending the card swiping operation.

Because different types of cards have different anti-counterfeit characteristics at different locations and may be covered with a laminated layer, the position detection module 222 detects the position of the inserted card and drives the card type recognition module 221 to recognize the type of the inserted card by means of measuring the length of the inserted card when the inserted card reaches a predetermined position. The position detection module 222 can be comprised of one or a number of reflective or penetrative optical sensors, a contact image sensor, or any other suitable type of sensor means. When the user moves the inserted card along the card-swiping slot 21 from the upper card-insertion section 211 toward the lower card-withdrawal section 212, the position detection module 222 detects the position of the card and drives the authenticity recognition module 223 to recognize the authenticity of the inserted card immediately when the card reaches a predetermined position during its movement from the upper card-insertion section 211 toward the lower card-withdrawal section 212. Because the authenticity recognition module 223 is started only when the inserted card reached a predetermined position and detected by the position detection module 222, the automatic vending machine raises the recognition accuracy of the authenticity recognition module 223 and saves much the power consumption of the authenticity recognition module 223.

When a card or bill is inserted into the insertion slot 31 of the bill acceptor unit 3, the inserted card will block the sensor switch 35, causing the sensor switch 35 to switch on the transmission device 33 and the recognition device 34, causing the transmission device 33 to carry the inserted card inwards to a predetermined position so that the sampling module 341 and optical recognition module 342 of the recognition device 34 can recognize the authenticity of the inserted card or bill and to identify the birthday data carried on the inserted card or the value of the inserted bill.

Further, the card recognition unit 4 allows insertion of a card (passport, driver's license, ID card, or insurance card) by a user for recognition. When a user inserted a card into the card slot 41 of the card recognition unit 4 to trigger the start switch 45, the start switch 45 immediately sends a signal to the microprocessor 42. Upon receipt of the signal from the start switch 45, the microprocessor 42 sends a signal to the host 1 to request the host 1 for providing power supply to the power supply module 46, and at the same time, starts the authenticity recognition device 43 and the light source 44 and drives the complicated programmable processing unit 421 to start the image sensor device 422 and the card position detection device 423. When started, the card position detection device 423 detects the position of the inserted card, and the image sensor device 422 picks up the image of the inserted card when the inserted card reaches a predetermined position.

The image sensor module 224 of the card-swiping unit 2, the sampling module 341 of the bill acceptor unit 3 and the image sensor device 422 and card position detection device 423 of the card recognition unit 4 can be respectively formed of a CCD (charge coupled device), CMOS (complementary metal-oxide semiconductor) or CIS (contact image sensor) or any other digital camera means capable of picking up the image of an inserted card for picture, character or authenticity identification.

The light utilized by the authenticity recognition module 223 of the card-swiping unit 2, the optical recognition module 342 of the bill acceptor unit 3 and the authenticity recognition device 43 of the card recognition unit 4 and the light provided by the light source 44 can be white light, green light, blue light, infrared light, ultraviolet light or any other wavelength light

When the authenticity recognition module 223, optical recognition module 342 or authenticity recognition device 43 is recognizing the anti-counterfeit characteristics (watermark, steel stamp, hidden barcode or laser mark) of an inserted card, the image sensor module 224, sampling module 341 or image sensor device 422 picks up a special mark from the card for recognition. Through these two light source recognition flows, the authenticity of the card is accurately identified to be a true card or counterfeit. Thereafter, the CPU 22, CPU 32 or microprocessor 42 gives a signal to the CPU 12 to stop the transaction if the card is identified to be a counterfeit, or to continuous the transaction if the card is identified to be a true card and the identity or age of the user is approved.

Further, when picked up the image of an inserted card, the image sensor module 224, sampling module 341 or image sensor device 422 runs OCR (optical character recognition) on the fetched image to compare the fetched birthday data with the current date, thereby determining whether or not the age of the cardholder is over a predetermined legal age. The comparison result is then sent to the CPU 12 of the host 1 by the CPU 22, CPU 32 or microprocessor 42, enabling the automatic vending machine to stop or continue the transaction subject to the comparison result. Further, the image sensor module 224, sampling module 341 or image sensor device 422 can also be designed to recognize the data of name and ID number/license number so that the system can record the data of the name, birthday and ID number of the trader and the trade item after each transaction.

The invention utilizes the authenticity recognition module 223, optical recognition module 342 or authenticity recognition device 43 to simultaneously recognize the authenticity of an inserted card and the age and identity of the cardholder. Further, the image sensor module 224, sampling module 341 or image sensor device 422 converts the anti-counterfeit characteristics of an inserted card been radiated by a light source into an image data for authenticity recognition. After recognition of the authenticity of the card, the birthday data carried on the card is recognized through an OCR (optical character recognition) process so that the cardholder is identified to be over a predetermined age or not, avoiding breaking the law due to selling of tobacco, liquor or any controlled item to a young child under a predetermined age. When selling a drug or hazardous item, the automatic vending machine can record the data of the name, birthday and ID or license number of the cardholder, the trade item as well as the transaction time after each transaction for further filing and search. Therefore, the invention protects automatic vending machine providers or sellers from other people's threatening or damage due to direct selling of controlled items. Further, the automatic vending machine can sell medicines so that any person suffering chronic diseases can purchase particular medicines from the automatic vending machine directly and needs not to go to a hospital for getting the same medicines. Further, the automatic vending machine can be linked to a video-monitoring safety system or police or government security system for criminal protection.

Referring to FIGS. 1, 3, 5 and 6, the host 1 starts transaction only after recognition of a card and receipt of a bill or coin. When making a transaction, a user can decide to insert a bill or coin into the automatic vending machine. When inserting a coin, the coin is inserted into the coin slot 51 of the coin acceptor 5. After insertion of a coin into the coin slot 51, the coin passes through the induction coil module 54. At this time, the induction coil module 54 is induced to validate the authenticity and value of the coin and the sensor module 55 is driven to detect the position of the coin and to have the any counterfeit coin be returned to the coin-return outlet 115 of the host 1.

When a bill is inserted through the insertion slot 31 of he bill acceptor 3, the inserted bill will trigger the sensor switch 35, causing the sensor switch 35 to provide a signal to the CPU 32. Upon receipt of the signal from the sensor switch 35, the CPU 32 drives the transmission device 33 to carry the inserted bill inwards, and simultaneously starts the sampling module 341 and optical recognition module 342 of the recognition device 34, causing the sampling module 341 and the optical recognition module 342 to recognize the authenticity and value of the bill. Subject to the control of the CPU 32, the transmission device 33 will carry the bill forwards further if the bill is a true money, or return the bill toward the outside if the bill is a counterfeit money.

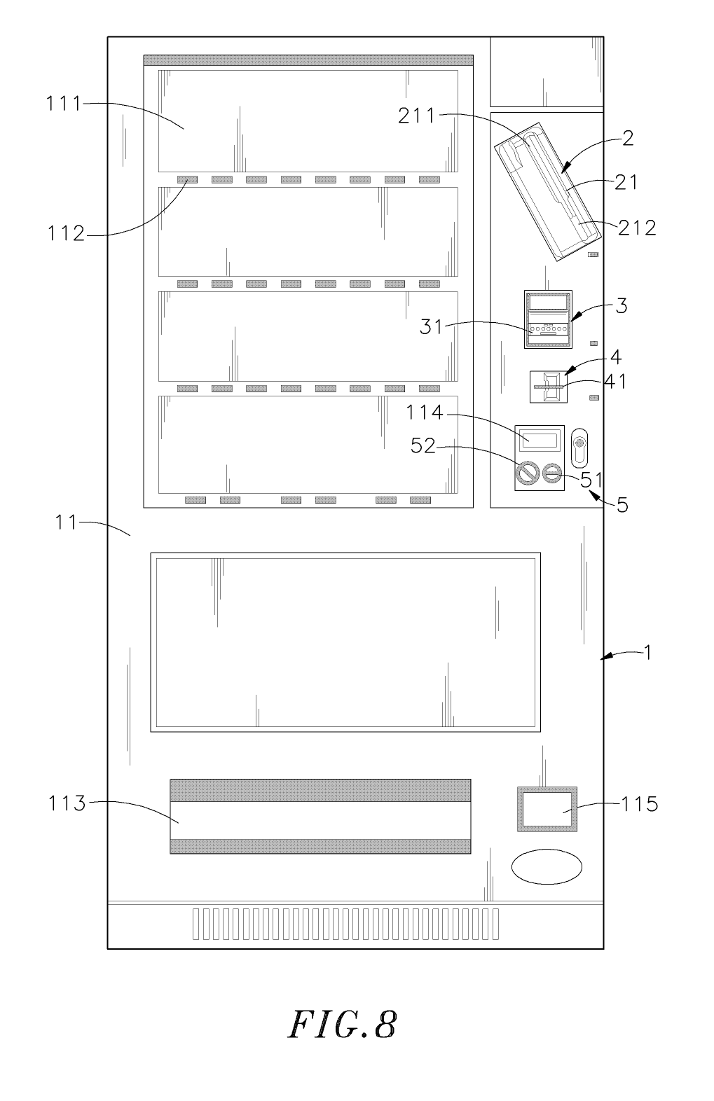

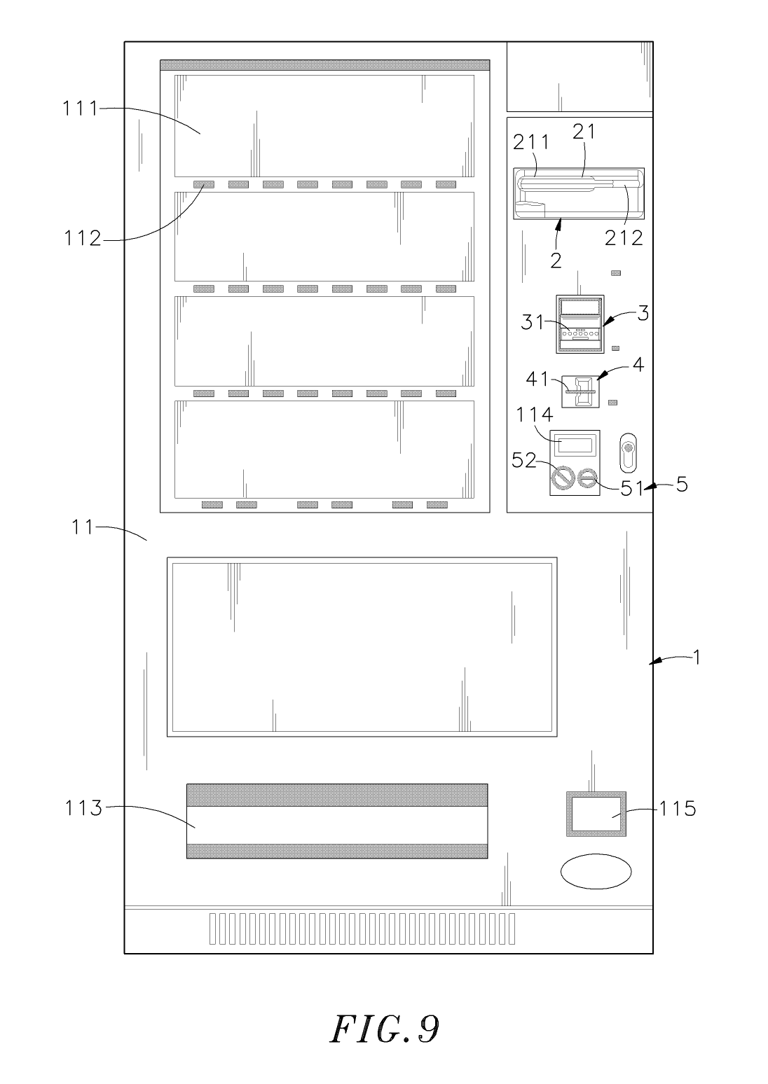

Referring to FIGS. 1, 8 and 9, the card-swiping slot 21 of the card-swiping unit 2 is formed in the face panel 11 of the host 1 at a suitable location so that a user can conveniently insert a card into the card-swiping unit 2 and swip the card, and then withdraw the card from the card-swiping unit 2. However, the card-swiping slot 21 can be formed in the face panel 11 in any direction. For example, the card-swiping slot 21 can be formed in the face panel 11 in a vertical position as shown in FIG. 1, an oblique position as shown in FIG. 8, or a horizontal position as shown in FIG. 9.

Further, the host 1 has a bill box (not shown) and a coin box (not shown) mounted therein for collecting each inserted true bill or coin. The procedure and mechanism for receiving each inserted true bill or coin are of the known art and not within the scope of the spirit of the present invention, and therefore no further description in this regard is necessary.

Further, the host 1 can have only the aforesaid card-swiping unit 2, bill acceptor unit 3 and coin acceptor unit 5 installed therein without the aforesaid card recognition unit 4. Alternatively, the host 1 can have only the aforesaid card-swiping unit 2, bill acceptor unit 3 and card recognition unit 4 installed therein without the aforesaid coin acceptor unit 5. Further, the card-swiping unit 2, the bill acceptor unit 3, the card recognition unit 4 and the aforesaid coin acceptor unit 5 can be independent units separately made, and then respectively installed in the host 1. Alternatively, the card-swiping unit 2, the bill acceptor unit 3, the card recognition unit 4 and the aforesaid coin acceptor unit 5 can be integrated into the host 1.

In conclusion, the invention provides an automatic vending machine with user's identity recognition function, which has the following advantages and features:

1. The host 1 starts a transaction to sell a controlled item only after the user has inserted a card into the card-swiping unit 2 or the card recognition unit 4 and the identity of the user has been identified and the user has inserted the bill or coin, avoiding any unqualified person to buy a controlled item from the automatic vending machine.

2. When the host 1, the card-swiping unit 2, the bill acceptor unit 3, the card recognition unit 4 and the aforesaid coin acceptor unit 5 are not in operation, the host 1 stops power supply from the card-swiping unit 2, the bill acceptor unit 3, the card recognition unit 4 and the aforesaid coin acceptor unit 5. When a user inserts a card into the card-swiping unit 2 to trigger the card type recognition module 221 or the card recognition unit 4 to trigger the start switch 45, or inserts a bill into the bill acceptor unit 3 to induce the sensor switch 35 or a coin into the coin acceptor unit 5 to induce the induction coil module 54, the host 1 immediately provides power supply to the card-swiping unit 2, the card recognition unit 4, the bill acceptor unit 3 or the coin acceptor unit 5, enabling the respective unit to recognize the authenticity of the inserted card and the identity of the cardholder, or the authenticity and value of the inserted bill or value. After the end of each transaction, the host 1 stops the supply of power supply again, saving electricity consumption.

In general, an automatic vending machine in accordance with the present invention comprises a host 1 having a face panel 11, and a card-swiping unit 2, a bill acceptor unit 3, a card recognition unit 4 and a coin acceptor unit 5 respectively inserted in the face panel 11 of the host 1. By means of the card-swiping unit 2 or the card recognition unit 4, the automatic vending machine recognizes the identity of the user before each transaction. Therefore, the automatic vending machine is practical for selling controlled and/or hazardous commodities to persons over a legal age.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An automatic vending machine comprising:
a host, said host comprising a face panel, a plurality of display compartments disposed in said face panel and adapted for holding and displaying commodities to be sold, a take-out port formed in said face panel near a bottom side of said host for enabling a user to take out each purchased commodity from said host, a plurality of commodity selection buttons respectively installed in said face panel corresponding to said display compartments, and a coin-return outlet formed in said face panel adjacent to said take-out port;
a card-swiping unit installed in said face panel of said host, said card-swiping unit comprising a card-swiping slot for enabling a user to insert and swip a card, an authenticity recognition module and an image sensor module, said card-swiping slot having an upper card-insertion section and a lower card-withdrawal section, said authenticity recognition module and said image sensor module being adapted for recognizing the authenticity of an inserted card;
a bill acceptor installed in said face panel of said host, said bill acceptor comprising an insertion slot for the insertion of a card and a bill separately, a transmission device adapted controllable to transfer an inserted true bill inwards toward the inside of said host and to transfer an inserted counterfeit bill backwards toward the outside of said host, and a recognition device adapted for recognizing the authenticity of an inserted card and the authenticity and value of an inserted bill; and
a coin acceptor unit installed in said face panel of said host, said coin acceptor unit comprising an insertion slot for the insertion of a coin, a coin-return button operable to let an inserted coin fall to said coin-return outlet, and an induction coil module adapted for recognizing the authenticity and value of an inserted coin.

2. The automatic vending machine as claimed in claim 1, wherein said host further comprises a display screen installed in said face panel.

3. The automatic vending machine as claimed in claim 1, wherein said host further comprises a central processing unit; said card-swiping unit further comprises a central processing unit electrically connected with said authenticity recognition module and said image sensor module of said card-swiping unit and the central processing unit of said host; said bill acceptor unit further comprises a central processing unit electrically conned with the transmission device and recognition device of said bill acceptor unit and the central processing unit of said host; said coin acceptor unit further comprises a central processing unit electrically connected with said induction coil module and the central processing unit of said host.

4. The automatic vending machine as claimed in claim 3, wherein said card-swiping unit further comprises a card type recognition unit adapted to recognize the type of an inserted card, and a position detection module adapted to detect the position of an inserted card.

5. The automatic vending machine as claimed in claim 4, wherein said position detection module is comprised of at least one sensor selected from a group of reflective optical sensors, penetrative optical sensors and contact image sensors.

6. The automatic vending machine as claimed in claim 3, wherein said card-swiping unit further comprises a power saving unit electrically connected to the central processing unit of said card-swiping unit, said power saving unit comprising a power-saving microprocessor and a power control module, said power control module being electrically connected to the central processing unit of said host, and a power supply module electrically connected to said power control module.

7. The automatic vending machine as claimed in claim 3, wherein said bill acceptor unit further comprises a sensor switch and a power supply module respectively electrically connected to the central processing unit of said bill acceptor, said sensor switch being adapted to detect the insertion of a bill and a card.

8. The automatic vending machine as claimed in claim 3, wherein said coin acceptor unit further comprises a sensor module electrically connected with the central processing unit of said coin acceptor unit and adapted to detect the insertion of a coin, and a power supply module electrically connected to the central processing unit of said coin acceptor unit.

9. The automatic vending machine as claimed in claim 8, further comprising a card recognition unit installed in said face panel of said host and adapted for receiving a card inserted by a user and recognizing the authenticity of the card, said card recognition unit comprising an insertion slot for the insertion of a card.

10. The automatic vending machine as claimed in claim 9, wherein said card recognition unit further comprises a microprocessor electrically connected with the central processing unit of said host, a complicated programmable processing unit electrically connected with the microprocessor of said card recognition unit, and an image sensor device and a card position detection device electrically connected to the microprocessor of said card recognition unit through said complicated programmable processing unit.

11. The automatic vending machine as claimed in claim 10, wherein said card recognition unit comprises an authenticity recognizer and a light source electrically connected with the microprocessor of said card recognition unit and adapted to recognize the authenticity of an inserted card, and a start switch electrically connected to the microprocessor of said card recognition unit and adapted to detect the insertion of a card into the insertion slot of said card recognition unit, and a power supply module electrically connected to the microprocessor of said card recognition unit.

12. The automatic vending machine as claimed in claim 1, wherein said card-swiping slot of said card-swiping unit is formed in said face panel of said host in a horizontal position.

13. The automatic vending machine as claimed in claim 1, wherein said card-swiping slot of said card-swiping unit is formed in said face panel of said host in a vertical position.

14. The automatic vending machine as claimed in claim 1, wherein said card-swiping slot of said card-swiping unit is formed in said face panel of said host in an oblique position.

15. The automatic vending machine as claimed in claim 1, wherein the recognition device of said bill acceptor comprises a sampling module adapted to fetch an image from an inserted card and an optical recognition module adapted for recognizing the authenticity of an inserted card or bill.
